(19) United States
(12) Patent Application Publication
(10) Pub. No.: US 2011/0115769 A1
(43) Pub. Date: May 19, 2011

(54) HYBRID IMAGE DISPLAY SYSTEMS AND OPERATING METHODS THREROF

(75) Inventors: Ming-Hua HSIEH, Shiding Township (TW); Heng-Lin PAN, Yonghe City (TW); Chen-Wei LIN, Kaohsiung City (TW); Yen-Shih HUANG, Hsinchu City (TW)

(73) Assignee: INDUSTRIAL TECHNOLOGY RESEARCH INSTITUTE, Chutung (TW)

(21) Appl. No.: 12/700,483

(22) Filed: Feb. 4, 2010

(30) Foreign Application Priority Data
Nov. 16, 2009 (TW) 098138784

(51) Int. Cl. G09G 3/32; G06F 3/038

(52) U.S. Cl. 345/211; 345/82

(57) ABSTRACT

A hybrid image display system and an operating method thereof. The system has an electro-phoretic display (EPD) element, an organic light emitting diode (OLED), a current generating circuit and a switch. The EPD element has a first and a second terminal. The OLED has an anode and a cathode. The current generating circuit has a power terminal, a control terminal and an output terminal, wherein the output terminal is coupled to the anode of the OLED. The switch is controlled by a scan signal. When the switch is turned on, a data signal is transmitted to the first terminal of the EPD element and to the control terminal of the current generating circuit.

### CROSS REFERENCE TO RELATED APPLICATIONS

This Application claims priority of Taiwan Patent Application No. 098138784, filed on Nov. 16, 2009, the entirety of which is incorporated by reference herein.

### BACKGROUND OF THE INVENTION

1. Field of the Invention

The present invention relates to image display systems, and in particular relates to hybrid image display systems with hybrid display cells.

2. Description of the Related Art

Electronic paper and organic light emitting, diode display (OLED display) are two common display techniques. Both of the electronic paper and OLED display do not require backlight modules.

The display cells in the electronic paper may be electro-phoretic display elements (EPD elements) so that the electronic paper is light and functional while requiring lower power. One of the drawbacks of the EPD elements is the slow response speed. Thus, EPD elements are limited to static image display or text display. It should be noted that the EPD element requires a relatively high voltage in order to operate.

In comparison with the EPD element, OLED has a faster response speed and supports high color representation. Thus, OLED displays are suitable for dynamic image displays. It should be noted that OLED displays require a lower operating voltage than EPD elements.

### BRIEF SUMMARY OF THE INVENTION

The invention discloses hybrid image display systems and provides operating methods of the hybrid image display systems.

A display cell of the hybrid image display system comprises an electro-phoretic display element (EPD element), an organic light emitting diode (OLED), a current generating circuit and a switch. The EPD element has a first terminal and a second terminal. The OLED has an anode and a cathode. The current generating circuit has a power terminal, a control terminal and an output terminal, wherein the output terminal is coupled to the anode of the OLED. The switch is controlled by a scan signal to transmit a data signal to both the first terminal of the ELD element and the control terminal of the current generating circuit while the switch is on.

In an exemplary embodiment, the power terminal of the current generating circuit is provided with a power signal, the cathode of the OLED is provided with a cathode signal, and the second terminal of the EPD element is provided with a common mode signal. By controlling the power signal, cathode signal and the common mode signal, the status of the display cell may be switched.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an exemplary embodiment of the display cell of the hybrid image display system;

FIG. 2 depicts an array of the display cells;

FIG. 3A depicts another exemplary embodiment of the image display system of the invention; and

FIG. 3B shows waveforms of the control signals.

### DETAILED DESCRIPTION OF THE INVENTION

The following description shows exemplary embodiments of the invention. This description is made for the purpose of illustrating the general principles of the invention and should not be taken in a limiting sense. The scope of the invention is best determined by reference to the appended claims.

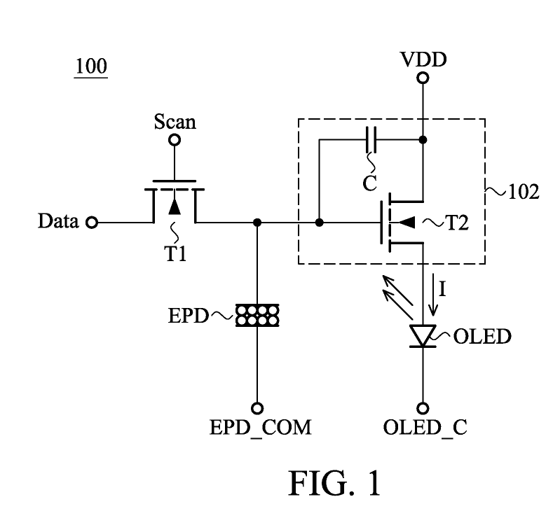

FIG. 1 depicts an exemplary embodiment of the display cell of the hybrid image display system. The display cell 100 comprises an electro-phoretic display element EPD, an organic light emitting diode OLED, a current generating circuit 102 and a switch T1. The electro-phoretic display element EPD comprises a first terminal and a second terminal, wherein the first terminal is coupled to a data signal via the switch T1, and the second terminal is provided with a common mode signal EPD_COM. The organic light emitting diode OLED comprises an anode and a cathode, wherein the anode is coupled to an output terminal of the current generating circuit 102 to receive current I, and the cathode is provided with a cathode signal OLED_C. The current generating circuit 102 has a power terminal, a control terminal and the said output terminal, wherein the power terminal is provided with a power signal VDD, and the control terminal is coupled to the data signal Data via the switch T1. The switch T1 is controlled by a scan signal Scan. When the switch T1 is on, the data signal Data is transmitted to the electro-phoretic display element EPD and the current generating circuit 102.

The display cell 100 shown in FIG. 1 is in a 2T1C structure. As shown, there are two switches T1 and T2 and one capacitor C. The voltage level stored in the capacitor C determines the conductance of the switch T2 and then determines the brightness of the organic light emitting diode OLED. As shown, one terminal of the capacitor C and the gate of the switch T2 may be connected together to form the control terminal of the current generating circuit 102.

Note that the display cell of the invention is not limited to the 2T1C structure of FIG. 1, and the current generating circuit 102 of FIG. 1 may be replace by other variants. No matter what structure implements the display cell, the display cell of the invention has several control terminals operative to receive the scan signal Scan, the data signal Data, the power signal VDD, the cathode signal OLED_C and the common mode signal EPD_COM. The display cells of the invention have high aperture ratio.

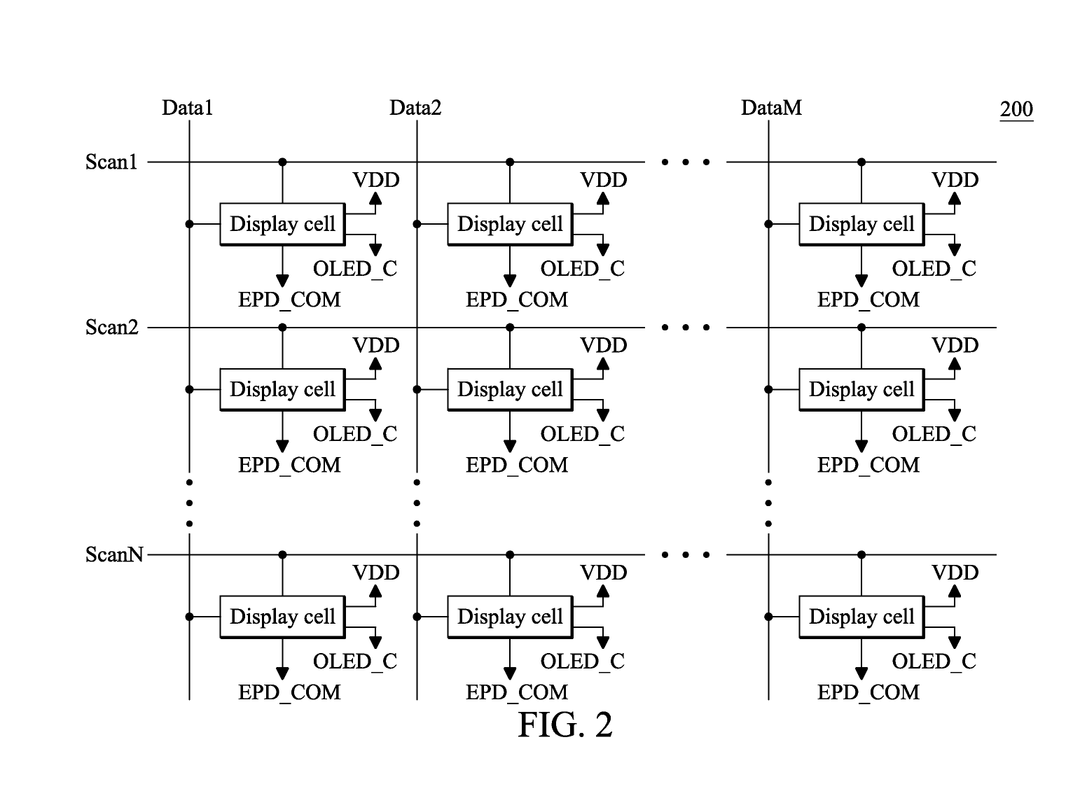

FIG. 2 depicts an array of the display cells 200. Scan signals Scan1, Scan2 . . . ScanN drive different rows in the array 200. Data signals Data1, Data2 . . . DataM are designed for different columns of the array 200.

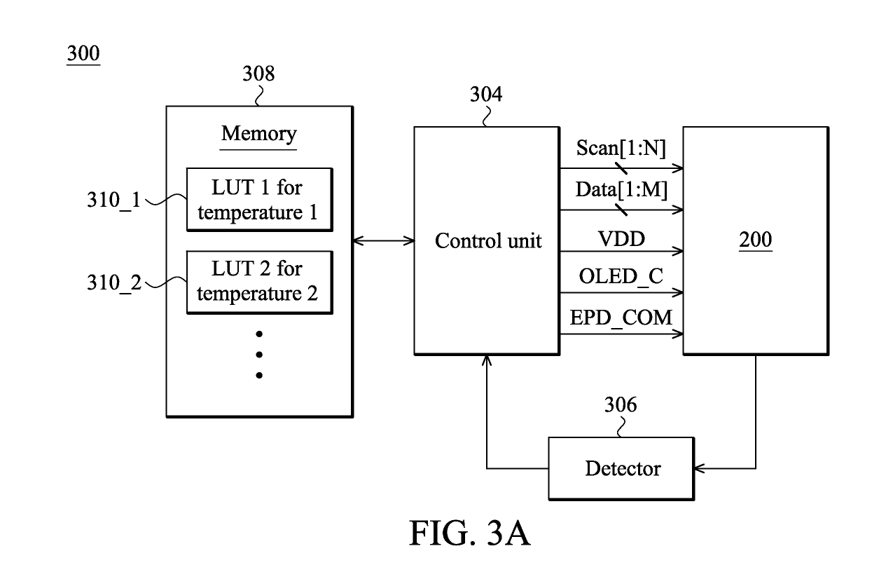

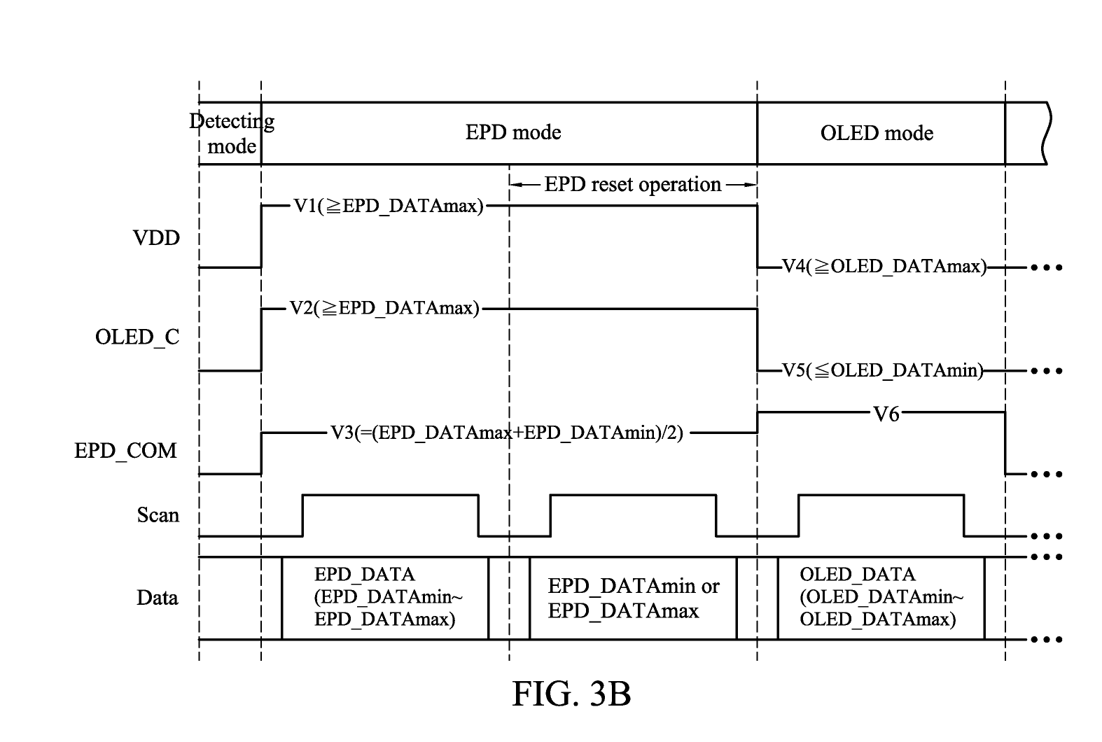

FIG. 3A depicts another exemplary embodiment of the image display system of the invention. In addition to the said display cell array 200, the system comprises a control unit 304 providing the display cell array 200 with scan signals Scan[1:N], data signals Data[1:M], power signal VDD, cathode signal OLED_C and common mode signal EPD_COM. The detector 306 and the memory 308 are optional components in the image display system.

FIG. 3B shows waveforms of the control. signals. Note that the data signal Data is operated within a first voltage range (labeled by EPD_DATA, between a minimum EPD data voltage level EPD_DATAmin and a maximum EPD data voltage level EPD_DATAmax) when the system is in an electro-phoretic display element mode (EPD mode), and is operated within a second voltage range (labeled by OLED_DATA, between a minimum OLED data voltage level OLED_DATAmin and a maximum OLED data voltage level OLED_DATAmax) when the system is in an organic light emitting diode mode (OLED mode).

This paragraph discusses how the control signals shown in FIG. 3B control the display cell 100 of FIG. 1. A detecting mode is designed prior to the EPD mode. In the detecting mode, the power signal VDD, the cathode signal OLED_C and the common mode signal EPD_COM are all at a low voltage level to ground the power terminal of the current generating circuit 102, the cathode of the organic light emitting diode OLED and the second terminal of the electro-phoretic display element EPD. Thus, the electro-phoretic display element EPD and the organic light emitting diode OLED are inactive in the detecting mode and the detector 306 of FIG. 3A can measure the temperature of the display cells accurately.

The temperature information collected during the detecting mode may be used in the EPD mode for compensating the display of the electro-phoretic display element EPD that is sensitive to temperature variation. For example, in the EPD mode, the data signal Data may be generated according to the temperature information which the detector 306 had collected during the detecting mode. The memory 308 of FIG. 3A is designed for the compensation. The memory 308 may contain several lookup tables 310_1, 310_2 . . . each corresponds to a specific temperature and is used in transforming a gray level to a voltage level. When the system is in the EPD mode, the control unit 304 selects one of the lookup tables from the memory 308 according to the detected temperature, and generates the data signals Data[1:M], according to the selected look-up table, for the electro-phoretic display elements in the system. The aforementioned detector 306 and the memory 308 are optional components and the detecting mode is an optional mode. Designers can select them or not depending on the budget and the need for image quality.

FIG. 3B also shows the control signals for the EPD mode. In the EPD mode, the power signal VDD is at a first voltage level V1, the cathode signal OLED_is at a second voltage level V2 and the common mode signal EPD_COM is at a third voltage level V3. The first and second voltage levels V1 and V2 may be greater than or equal to the maximum EPD data voltage level EPD_DATAmax. For example, in an exemplary embodiment, the first and second voltage levels V1 and V2 may be set to the maximum EPD data voltage level EPD_DATAmax. Furthermore, the value of the third voltage level V3 is specially designed, too. In the EPD mode, the third voltage level V3 may be, (EPD_DATAmax+EPD_DATAmin)/2, the average of the maximum EPD data voltage level EPD_DATAmax and the minimum EPD data voltage level EPD_DATAmin.

The status of the signals VDD, OLED_C and EPD_COM make the organic light emitting diode OLED inactive in the EPD mode so that the display of the electro-phoretic display element EPD is not affected by the organic light emitting diode OLED in the EPD mode. Furthermore, because the power signal VDD and the cathode signal OLED_C are set to be greater than or equal to the maximum EPD data voltage level EPD_DATAmax, the switch T2 of the current generating circuit 102 is protected from being stressed by the high voltage applied at the gate of the switch T2 (wherein the great voltage is from the data signal Data that may reach the maximum EPD data voltage level EPD_DATAmax during the EPD mode). Thus, the lifetime of the switch T2 can be extended.

FIG. 3B further discloses an EPD reset operation at the end of the EPD mode. During the EPD reset operation, the power signal VDD, the cathode signal OLED_C and the common mode signal EPD_COM are maintained at their original settings, the first second and third voltage levels V1, V2 and V3, respectively. As for the data signal Data, all display cells in the system are unified to display the same data. For example, the data signals are all set to be the maximum EPD data voltage level EPD_DATAmax or the minimum EPD data voltage level EPD_DATAmin to make the all EPD elements in the system to have the same brightness and so that the displayed image is the brightest image or the darkest image. Thus, the EPD elements do not affect the image display of the system after the system leaving the EPD mode.

FIG. 3B further shows control signals in the OLED mode. During the OLED mode, the power signal VDD is at a fourth voltage level V4, the cathode signal OLED_C is at a fifth voltage level V5 and the common mode signal EPD_COM is at a sixth voltage level V6. The fourth voltage level V4 is designed to be greater than or equal to the maximum OLED data voltage level OLED_DATAmax. The fifth voltage level V5 is lower than or equal to the minimum OLED data voltage level OLED_DATAmin. The sixth voltage level V6 may be set to be greater than or equal to the maximum OLED data voltage level OLED_DATAmax or to be lower than or equal to the minimum OLED data voltage level OLED_DATAmin. Because the common mode voltage level EPD_COM is limited in the specific voltage range during the OLED mode, the electro-phoretic display element EPD maintains its display that has been set by the EPD reset operation and does not affect the image of the system in the OLED mode.

According to the techniques disclosed the specification, users can switch the system between the EPD mode and the OLED mode freely. For example, switching the system to the OLED mode while displaying dynamic images itching the system to the EPD mode while displaying text images.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hybrid image display system, wherein a display cell therein comprises:
an electro-phoretic display element (EPD element), having a first terminal and a second terminal;
an organic light emitting diode (OLED), having an anode and a cathode;
a current generating circuit, having a power terminal, a control terminal and an output terminal, wherein the output terminal is coupled to the anode of the OLED; and
a switch, controlled by a scan signal to transmit a data signal to the first terminal of the EPD element and to the control terminal of the current generating circuit when being conductive.

2. The system as claimed in claim 1, further comprising:
a control unit, providing the power terminal of the current generating circuit with a power signal, providing the cathode terminal of the OLED with a cathode signal, providing the second terminal of the EPD element with a common mode signal, and providing said scan signal and data signal to the display cell.

3. The system as claimed in claim 2, wherein:
when the system is in an EPD mode, the control unit sets the power signal to a first voltage level, the cathode signal to a second voltage level, and sets the common mode signal to the third voltage level,
wherein the first and second voltage levels are greater than or equal to a maximum EPD data voltage level, and the third voltage level is an average of the maximum EPD data voltage level and a minimum EPD data voltage level.

4. The system as claimed in claim 3, wherein:
at the end of the EPD mode, the control unit further provides a EPD reset operation to set the data signal to the maximum EPD data voltage level or the minimum EPD data voltage level according to status of the other EPD elements of the system, to unify the brightness of the all EPD elements of the system.

5. The system as claimed in claim 4, wherein:
when the system is in an OLED mode, the control unit sets the power signal to a fourth voltage level, the cathode signal to a fifth voltage level and sets the common mode signal to a sixth voltage level,
where:
the fourth voltage level is greater than or equal to a maximum OLED data voltage level;
the fifth voltage level is lower than or equal to a minimum OLED data voltage level; and
the sixth voltage is greater than or equal to the maximum OLED data voltage level or lower than or equal to the minimum OLED data voltage level.

6. The system as claimed in claim 3, further comprising a detector which detects temperature while the system is in detecting mode.

7. The system as claimed in claim 6, wherein:
when the system is in the detecting mode the control unit grounds the power terminal of the current generating circuit, the cathode of the OLED and the second terminal of the EPD element by setting the power signal, the cathode signal and the common mode signal.

8. The system as claimed in claim 7, wherein the control unit generates the data signal according to the temperature the detector had detected during the detecting mode.

9. The system as claimed in claim 8, further comprising a memory which stores a plurality of lookup tables corresponding to the various temperatures and to be selected by the control unit in order to generate the data signal according to the temperature the detector had detected during the detecting mode.

10. A method for operating an image display system, comprising:
providing a display cell comprising:
an electro-phoretic display element (EPD element), having a first terminal and a second terminal;
an organic light emitting diode (OLED), having an anode and a cathode;
a current generating circuit, having a power terminal, a control terminal and an output terminal, wherein the output terminal is coupled to the anode of the OLED; and
a switch, controlled by a scan signal to transmit a data signal to the first terminal of the EPD element and the control terminal of the current generating circuit when being conductive;
providing the power terminal of the current generating circuit with a power signal, providing the cathode of the OLED with an cathode signal, and providing the second terminal of the EPD element with a common mode signal; and
setting the status of the display cell by controlling the power signal, the cathode signal and the common mode signal to switch the image display system between an EPD mode and an OLED mode.

11. The method as claimed in claim 10, wherein the step of switching the image display system to the EPD mode comprising:
setting the power signal to a first voltage level;
setting the cathode signal to a second voltage level; and
setting the common mode signal to a third voltage level;
wherein the first and second voltage levels are greater than or equal to a maximum EPD data voltage level and the third voltage level is an average of the maximum EPD data voltage level and a Minimum EPD data voltage level.

12. The method as claimed in claim 11, further comprises performing an EPD reset operation at the end of the EPD mode, wherein the EPD reset operation comprises:
setting the data signal to the maximum EPD data voltage level or to the minimum EPD data voltage level according to status of the other EPD elements in the image display system to unify the brightness of all EPD elements of the image display system.

13. The method as claimed in claim 12, wherein a step of switching the image display system to the OLED mode comprising:
setting the power signal to a fourth voltage level;
setting the cathode signal to a fifth voltage level; and
setting the common mode signal to a sixth voltage level;
where:
the fourth voltage level is greater than or equal to a maximum OLED data voltage level;
the fifth voltage level is lower than or equal to a minimum OLED data voltage level; and
the sixth voltage level is greater than or equal to the maximum OLED data voltage level, or lower than or equal to the minimum OLED data voltage level.

14. The method as claimed in claim 11, further comprising:
providing a detector which detects the temperature while the image display system is in detecting mode.

15. The method as claimed in claim 14, wherein the step of switching the image display system to the detecting mode comprises:
grounding the power terminal of the current generating circuit, the cathode of the OLED and the second terminal of the EPD by setting the power signal, the cathode signal and the common mode signal.

16. The method as claimed in claim 15, comprising:
when the image display system is in the EPD mode, generating the data signal based on the temperature the detector had detected during the detecting mode.

17. The method as claimed in claim 16, further comprising:
providing a memory storing a plurality of lookup tables corresponding to various temperatures and to be selected in order to generate the data signal according to the temperature the detector had detected during the detecting mode.
